(19) United States
(12) Patent Application Publication
(10) Pub. No.: US 2011/0056622 A1
(43) Pub. Date: Mar. 10, 2011

(54) Method of Forming Temperature Regulating Article

(76) Inventors: Raymond M. Booska, West Melbourne, FL (US); Steven L. Wuest, West Melbourne, FL (US)

(21) Appl. No.: 12/943,895

(22) Filed: Nov. 10, 2010

Related U.S. Application Data
(62) Division of application No. 10/944,338, filed on Sep. 17, 2004.
(60) Provisional application No. 60/561,094, filed on Apr. 9, 2004.

(51) Int. Cl. B29C 65/14; B32B 37/00

(52) U.S. Cl. 156/272.2; 156/60; 156/293

(57) ABSTRACT

Methods and apparatus for regulating temperature are described. An apparatus for regulating temperature can include a phase change material and a pliable membrane. The phase change material is derived from one or more agricultural products and is therefore renewable. The phase change material transitions between a solid state and a liquid state between about −10° C. and about 65° C. The pliable membrane is configured to enclose the phase change material.

This application is a divisional of U.S. application Ser. No. 10/944,338, filed Sep. 17, 2004, which claims the benefit of U.S. Provisional Application No. 60/561,094, filed on Apr. 9, 2004, each of which is incorporated by reference herein.

### BACKGROUND

This invention relates to regulating temperature with a material that stores latent heat.

Phase change materials, or PCM, are a class of materials that have high heats of fusion and can absorb a great amount energy before melting. A PCM stores latent thermal energy and remains at a constant temperature during phase change, such as during melting or freezing. Because of the ability to store a great deal of latent thermal energy, a PCM can release or store more energy without a commensurate change when compared to other materials. This property can be harnessed to regulate the temperature of an environment or object for an extended time. The use of ice as a thermal storage material for food is an example of this principle. Water is charged by freezing to remove energy from the water and form ice. As heat energy is transferred to the ice, such as by placing the ice in a warm liquid, each unit of heat energy transferred to the ice is absorbed by the water molecules. Not until sufficient energy has been transferred to the water molecules is the ice able to melt. The temperature of the ice stays constant until the phase change from solid to liquid is complete. The melted ice, or water, then increases in temperature as more energy is transferred to the water.

In many PCMs, the phase changes are reversible so that the latent heat storage can be used for either heating or cooling. That is, the PCMs release energy as the material changes from a liquid to a solid. Thus, the latent heat stored or released during the phase change can be used for cooling or heating, depending on how the PCM is charged and the temperature of the surrounding environment.

PCMs can be used in personal heating and cooling devices or devices around the house. Examples of such PCMs include packets with a PCM salt or hydrocarbon, such as paraffin, that can be heated and inserted into a boot or mitten for keeping feet and hands warm in a cold environment. Other PCMs can be heated or cooled and inserted into an insulated jacket for keeping food items at a desired temperature for a longer time than if the food was left in the open air. The PCMs in these items are typically synthetic or derived from petroleum products.

### SUMMARY

In general, the invention provides techniques for using a recyclable phase change material to regulate the temperature of an object or a body. The recyclable phase change material can act as a heat sink to absorb heat of a body or a heat source to provide heat to the body.

In general, in one aspect, the invention features methods and apparatus for regulating temperature. The apparatus can include a phase change material and a pliable membrane. The phase change material is derived from one or more agricultural products wherein the phase change material transitions between a solid state and a liquid state between about −10° C. and about 65° C. The pliable membrane is configured to enclose the phase change material.

The phase change material can include a fatty acid, fatty-acid derivative or triglyceride. The phase change material can be derived from soybean, palm, coconut, sunflower, rapeseed, cottonseed, linseed, caster, peanut, olive, safflower, evening primrose, borage, carboseed or animal products. The phase change material can be substantially free of salts or hydrocarbons. The pliable membrane can include polyurethane, vinyl, polyvinylchloride, polyester, polyether urethane, urethane or a combination thereof.

In another aspect, an article for regulating a body temperature is described. The article includes a fabric having one or more pockets and a bladder made of a pliable membrane. The bladder is configured to retain a phase change material from one or more agricultural products, wherein the phase change material transitions between a solid state and a liquid state between about −10° C. and about 65° C. The pockets are configured to fit a bladder. The article can be clothing, such as a vest, shirt, undergarment, a garment liner, jacket, trousers, socks, gloves or underwear. The article can also be a blanket or a wrap.

A method of forming a temperature regulating article is described. The method includes selecting one or more phase change materials, wherein the phase change materials are derived from one or more agricultural products and transitions between a solid state and a liquid state between about −10° C. and about 65° C. A piece of pliable material is cut to a desired size. A bladder with an opening is created from the pliable material. The bladder is filled through the opening with the one or more phase change materials derived from one or more agricultural products. The opening of the bladder is sealed closed so that the one or more phase change materials do not escape the bladder.

Implementations of this invention may include none, one or more of the following advantages. Renewable PCMs (RPCMs) may be more environmentally friendly than traditional PCMs. RPCMs are typically non-toxic to animals, including human beings. Because RPCMs are typically non-toxic, the RPCMs may be a source of food. RPCMs can be biodegradable and non-carcinogenic. RPCMs may be safer to work with. The temperature of the phase transition of an RPCM may be easier to control than the phase transition temperature of a traditional PCM. An RPCM with a relatively high phase change temperature may be capable of absorbing or radiating more heat energy than a traditional PCM with a similar phase change temperature. An RPCM may be charged, i.e., cooled or heated, more quickly than a traditional PCM. An RPCM may have a longer working lifespan per gram weight as compared to a traditional PCM. RPCMs can be safe to microwave. Manufacture and disposal of the RPCM can be simpler than that of PCM. The raw materials for RPCMs are readily available from agricultural sources.

Packaged or encapsulated RPCMs allow people to work in greater comfort in environments that are hot or cold. The RPCM bladders can also provide medical benefits, such as for use in blankets or wraps for people or animals with hyperthermia or hypothermia. Anyone needing a body temperature regulated, such as a person with a fever or a person with multiple sclerosis who benefits from having the body cooled, can benefit from a charged RPCM. An added benefit can be the reduced risk of injury if the bladder fails and releases the RPCM into the environment or onto the user.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 shows one implementation of a bladder assembly containing recyclable phase change material.

FIG. 2 is a cross sectional view of a bladder assembly containing recyclable phase change material.

FIG. 3 is a flow diagram describing the manufacture of a bladder containing the phase change material.

FIG. 4 shows an example of a garment in which a bladder can be inserted.

Like reference symbols in the various drawings indicate like elements.

### DETAILED DESCRIPTION

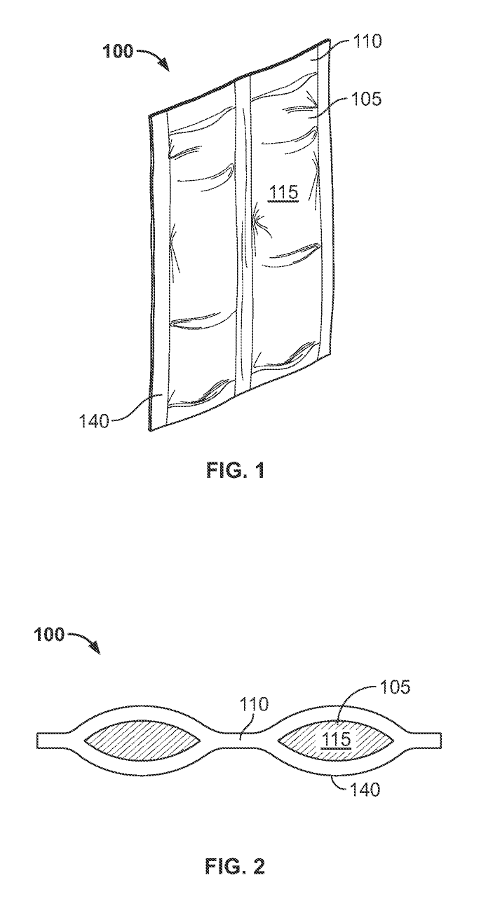

As shown in FIGS. 1 and 2, a bladder encloses a phase change material (PCM). The bladder assembly 100 can be formed from a pliable membrane 140 and can include one or more bladders each having a cavity 105. Each cavity 105 can be filled with renewable PCM 115 (RPCM). The bladder assembly 100 has a seal 110 that is sufficiently wide that the seal 110 does not rupture and the RPCM does not escape from the filled cavity 105 due to a seal failure.

The RPCM 115 is produced from agricultural products, such as biomass, including animal products and plants. The agricultural products from which the RPCM 115 can be derived include, but are not limited to, soybean, palm, coconut, sunflower, rapeseed, cottonseed, linseed, caster, peanut, olive, safflower, evening primrose, borage, carboseed and animal products, such as animal tallow. The RPCMs can include the oils, fats, fatty acids or fatty-acid derivatives of the agricultural starting material.

The RCPM can be formed by mixing desired agricultural materials, causing reversible ester bond chemistry to occur and separating fractions with the desired latent heat properties. The agricultural materials can include triglycerides, such as fatty acid glycerides, hydrates of acids of triglycerides, esters of fatty acids of naturally occurring triglycerides, esters of fatty acids created by alcoholyis and hydrolysis, followed by esterification, synthesized triglycerides, such as products produced by fractionation and transesterification, hydrogenation and fractionation or cis-trans isomerization and fractionation.

Pure fatty acids or mixtures of a few types of fatty acids tend to have latent heat temperature ranges that are narrower than a mixture including a large quantity of components. However, if a pure fatty acid does not have the desired phase change temperature, multiple fatty acids can be combined to achieve the desired phase change temperature range.

In one implementation of forming an RPCM, two triglycerides are mixed, each with a different phase change temperature. The mixture is heated to a temperature sufficient to cause a transesterification reaction. The mixture is then cooled and the solid fraction with a desired phase change temperature is separated out. The remaining material can be reintroduced into the process as starting material to form the desired RPCM. A solvent, such as acetone, volatile ethers and volatile hydrocarbons can be used in the reaction to improve separation. The solvent can be removed from the final product, such as by volatilization. Alternatively, an anti-solvent that reduces viscosity and displaces the liquid product from the solid derivatives during the solid-liquid separation step can be introduced into the process. Catalysts, such as catalysts that promote transesterification, alcoholysis or other ester bond chemistry, can be used in the above method. The RPCM can be refined, such as by purification or multiple fractionation steps, to select for a specific desired phase change temperature.

In one implementation, the resulting RPCM includes a composition that is mostly made up of tryiglycerides. In one implementation, the natural product has the desired latent heat properties and no processing or only fractionation of the starting materials is required.

Other appropriate methods of forming the desired RPCM can also be substituted for the methods described above. For example, triglycerides can be hydrogenated to increase the freezing point. Additional products can also be added to the RPCM product, such as water. Because the RPCM is formed from agricultural products, the RPCM is substantially free from salts or hydrocarbons. The RPCM can have a substantially transparent appearance and can have no color or a slight yellow or brown hue.

The RPCM stores a large amount of energy above the phase change temperature. To melt, or go from a solid to a liquid state, the RPCM must absorb a great amount of energy, such as heat. Conversely, to freeze, the RPCM must release a great amount of energy. The RPCM can have a phase transition between about −10° C. and 65° C. The phase transition temperature, or range of temperatures, can be selected based on the intended RPCM use, as described further below. In one implementation, the RPCM has two or more transition temperatures.

The bladder assembly 100 can be formed from a material that permits heat transfer. The material can be a pliable membrane, such that the bladder assembly can be easily deformed. The membrane should be sufficiently thick so that bladder is durable. However, the membrane need not be so thick as to diminish the pliable nature of the membrane. The membrane can be formed of a material that is sufficiently impermeable to prevent the RPCM from seeping through the membrane. The membrane can be formed from a plastic, such as aliphatic or aromatic plastics, including polyurethane, urethanes, extruded urethanes, polyether, polyether urethane, polyvinyl chloride, vinyl, polyethylene and other suitable materials or a combination thereof. Alternatively, the membrane can comprise a fabric impregnated with a plastic material. The membrane can have a thickness of between 1 and 50 mils, e.g., between about 2 and about 20 mils. The thickness of the seal 110 can be between an eighth of an inch and three quarters of an inch, such as around a quarter of an inch.

The size of each cavity 105 can be optimized based on the intended use of the bladder assembly. For smaller applications, small bladders can be formed, where each bladder includes about 10 to 50 grams of RPCM material. Smaller quantities of material may have a shorter useful duration per charge than larger quantities of material. However, a greater number of bladders can be formed in the bladder assembly, compensating for the size of each bladder. Further, the bladder assembly can be more flexible than a bladder assembly with larger bladders. Larger bladders can be formed, each bladder holding about 50 to about 1000 grams per bladder or more, for larger applications.

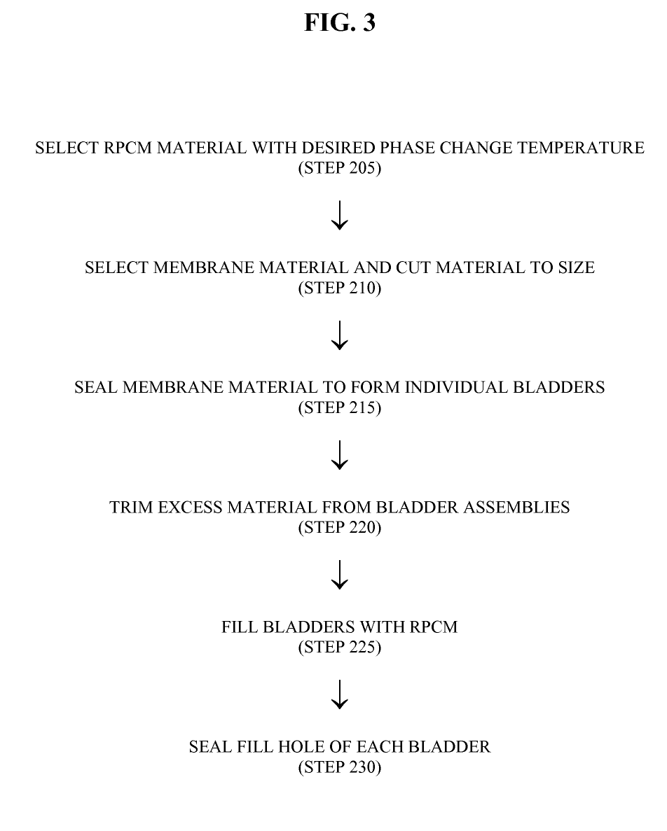

As shown in FIG. 3, the formation of the bladder assembly can occur as follows. An RPCM material having a desired phase change temperature range is selected (step 205). The range can be selected based on the intended use for the bladder. If the RPCM is to be used to keep an object cool in comparison to room temperature, an RPCM with a lower phase change temperature range is selected, such as between about −10° C. and about 15° C. In one implementation, the RCPM bladder is to keep a human cool in a hot environment. The RPCM that is selected can have a phase change that is lower than the maximum normal skin temperature of a human. If the RPCM is to keep an object warm, an RPCM is selected to have a phase change temperature range that is greater than 15° C., up to about 65° C. In one implementation, the RCPM bladder is to keep a human warm in a cool environment. The RPCM that is selected can have a phase change that is higher than the minimum normal skin temperature of a human.

A membrane material is selected for the bladder assembly and cut to the desired size (step 210). The tools used for cutting and supporting the membrane material can be grounded to reduce the build up of static charge during handling and cutting of the membrane material. The membrane material is sealed to form individual bladders each with a cavity (step 215). The sealing step forms the cavities sized to retain the desired quantity of RPCM. The sealing leaves a fill hole open for subsequent access to the cavity. In one implementation, the sealing is performed with an RF welder. The sealing creates a seal or seam with the desired width. Any excess membrane material can then be trimmed from the bladders (step 220).

The cavities of the bladders are then filled with a predetermined amount of RPCM through the fill hole (step 225). More than one RPCM can be used to fill each bladder. If the two RPCMs used to fill a bladder have different phase change temperatures, the combined material in the bladder can change phase at two temperatures. The bladders can be filled so that no air is present inside the cavity. To facilitate filling the bladders, the RPCM can be heated above the phase change temperature to liquefy the RPCM. The bladders can be filled so that no air remains inside the bladder after the bladders are complete.

The fill hole is then sealed (step 230). The fill hole can be heat sealed or RF welded. The bladders can then be washed to remove any excess RPCM material. A final optional sealing step can be performed to improve the seal.

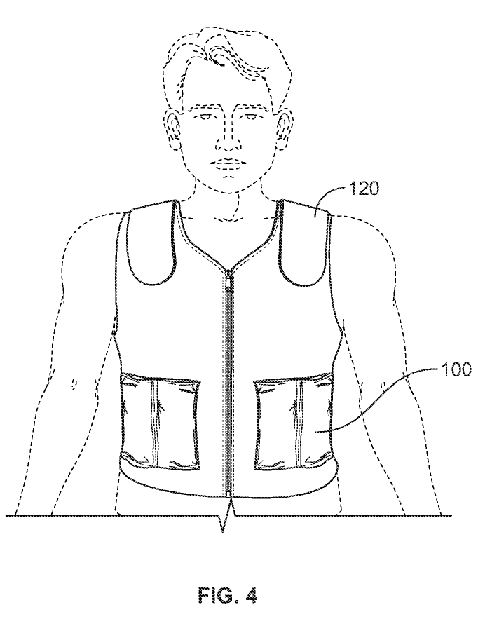

As shown in FIG. 4, the bladder assembly 100 that is described above can be used in combination with a covering. In one implementation, the bladder assembly 100 can be inserted into a pocket of a garment 120 or other article that permits the transfer of heat between a user and the RPCM. Alternatively, the bladder can be placed directly on the surface of an object, such as the skin of a user.

The covering can include a garment, such as clothing for a human or other animal, or a blanket or wrap for a human or other animal. The garment can be formed of a natural or synthetic textile. A layer of insulation can be placed between the bladder assembly 100 and the user or the bladder and the environment. In one implementation, the garment 120 includes a material suitable for absorbing moisture, such as rain or perspiration, to improve the comfort of the user. In one implementation, the garment is made of a fabric having heat conductive pathways for thermal equalization. In one implementation, the garment is made of a fabric that has improved heat absorption or rejection properties. In another implementation, the garment has an external thermal insulation layer and an internal thermal control layer to modify the surface temperature experienced by user. In one implementation the garment has multiple pockets. Each pocket can be filled with a bladder having an RPCM that changes phase at a different temperature. For example, a bladder with an RPCM that changes at a lower temperature can be placed in an outer pocket further from the wearer and a bladder with an RPCM that changes phase at a higher temperature can be placed in an inner pocket that is closer to the wearer.

The covering can have one or more pockets that are sized to fit a bladder assembly. The pockets can be open at one end for inserting the bladder. The pockets can have a closure, such as a tie, zipper, snap or button, to prevent the bladder assembly from sliding out of the pocket.

Exemplary applications of the RPCM bladder assembly include a vest or liner for use inside a chemical or environmental protection suit, an undergarment to sporting clothes, such as fire retardant racing suits, sports uniforms or equipment. A garment can include a shirt, undergarments, a garment liner, a jacket or trousers. Military uniforms and any of a variety of clothing designed for particular occupations can incorporate the bladders. The bladders can be used in gloves, shoes, socks or caps, such as in cold weather environments. The bladder assemblies can be used in medical applications. A metabolic heating or cooling blanket useful for treating hypothermia or hyperthermia can include the RPCM bladders. The bladder assemblies can also be incorporated into clothing for wear by persons diagnosed with multiple sclerosis to cool the body and bring down core body temperature.

To use the RPCM bladders, a user need only place the bladder in a heating or cooling apparatus to charge the material. Conduction charges the RPCM material more quickly and efficiently than convection. Therefore, ice water baths can recharge the bladder more quickly than placing the RPCM in a refrigerator or freezer. To heat the RPCM, the bladder can be placed in an oven, a microwave or any other heater capable of transferring sufficient energy to the RPCM and bringing the RPCM to the desired temperature. The charged RPCM bladder can then be inserted into the pocket of an item for use as described above. The charged RPCM is ready for regulating the temperature of a body or object, providing environmental buffering or maintaining a constant temperature of a body or object.

Renewable PCMs are safer for the environment than traditional PCMs. RPCMs are typically non-toxic to animals, including human beings. Because RPCMs are typically non-toxic, the RPCMs can be used as source of food. RPCMs are biodegradable and non-carcinogenic. Traditional PCMs can be harmful if ingested by animals. Traditional PCMs can be narcotic in high concentrations, have been observed to be severe irritants and highly destructive to tissues of mucous membranes, the upper respiratory tracts, the eyes and skin. RPCMs can be safer to work with. Control measures for clean up of traditional PCMs typically include protective garments, eye protection and self contained breathing apparatus. Because the RPCMs are not regulated by regulatory agencies, disposal of the RPCM products is simpler.

The raw materials for forming the RPCM are readily available from agricultural sources. Many traditional PCMs are derived from crude oil, which is a limited resource.

The temperature of the phase transition of an RPCM can be easier to select for than in a traditional PCM. A variety of RPCMs can be combined to achieve multiple phase change temperatures or a phase change that occurs over a range of temperatures. An RPCM with a relatively high phase change temperature may be capable of absorbing or radiating more heat than a traditional PCM with a similar phase change temperature. An RPCM can charge, i.e., be cooled or heated, more quickly than a traditional PCM. RPCM may have a longer working lifespan than per gram weight than a traditional PCM. RPCMs are safe to microwave. Per charge, each RPCM bladder can regulate temperature from between about a half hour to several hours, depending on the phase change temperature, the environmental conditions and the body that comes in contact with the bladder.

Packaged or encapsulated RPCMs allow people to work in greater comfort in environments that are hot or cold. A garment including a charged RPCM bladder can provide added comfort for a person who is must wear clothing that normally causes the wearer to be uncomfortably warm. The RPCM bladders can also provide medical benefits, such as for use in blankets or wraps for people or animals with hyperthermia or hypothermia. Anyone who needs to have their body temperature regulated, such as a person with a fever or with multiple sclerosis who benefits from having the body cooled can benefit from a charged RPCM. An added benefit can be the reduced risk of injury if the bladder fails and releases the RPCM onto the user.

A number of embodiments of the invention have been described. Nevertheless, it will be understood that various modifications may be made without departing from the spirit and scope of the invention. Accordingly, other embodiments are within the scope of the following claims.

What is claimed is:

1. A method of making a temperature regulating article, comprising:
mixing two triglycerides having different phase change temperatures to provide a mixture, the triglycerides derived from one or more agricultural products;
heating the mixture to a temperature sufficient to cause transesterification;
cooling the mixture and separating a solid portion to provide a phase change material derived from the one or more agricultural products that transitions between a solid state and a liquid state between about −10° C. and about 65° C.;
creating a bladder from a pliable material, the bladder having a cavity and an opening;
filling the cavity of the bladder through the opening with at least 10 grams and up to 100 grams of the phase change material; and
sealing the opening of the bladder closed so that the phase change material does not escape the bladder.

2. The method of claim 1, further comprising inserting the bladder into a pocket formed of a fabric.

3. The method of claim 2, wherein inserting the bladder into a pocket comprises inserting the bladder into a garment or a blanket.

4. The method of claim 1 wherein mixing two triglycerides comprises mixing two triglycerides derived from the group of agricultural products consisting of soybean, palm, coconut, sunflower, rapeseed, cottonseed, linseed, caster, peanut, olive, safflower, evening primrose, borage, carboseed, animal fat, animal grease, and a combination thereof.

5. The method of claim 1, wherein mixing the two triglycerides, heating the mixture, and cooling and separating the solid portion provides the phase change material to be substantially free from salts.

6. The method of claim 1, further comprising selecting the pliable membrane to have a thickness between about 2 and 20 mils thick.

7. The method of claim 1, further comprising selecting the pliable membrane to include a material from the group consisting of polyurethane, vinyl, polyvinylchloride, polyester, polyether urethane, urethane and a combination thereof.

8. The method of claim 1, wherein mixing the two triglycerides, heating the mixture, and cooling and separating the solid portion provides the phase change material to have a single transition temperature.

9. The method of claim 8, wherein the single transition temperature is less than the maximum normal skin temperature of a human.

10. The method of claim 9, wherein the single transition temperature is greater than the minimum normal skin temperature of a human.

11. The method of claim 1, wherein mixing the two triglycerides, heating the mixture, and cooling and separating the solid portion provides the phase change material that undergoes a solid-solid transition.

12. The method of claim 1, wherein filling the bladder comprises filling so that no air remains in the cavity.

13. The method of claim 1, further comprising placing the bladder filled with the phase change material in an environment capable of augmenting the temperature of the phase change material until the phase change material substantially reaches a desired temperature.

14. The method of claim 13, further comprising inserting the bladder into a pocket formed of a fabric after the phase change material substantially reaches the desired temperature.

15. The method of claim 13, wherein placing the bladder filled with the phase change material in the environment capable of augmenting the temperature includes placing the bladder in an ice bath.

16. The method of claim 13, wherein placing the bladder filled with the phase change material in the environment capable of augmenting the temperature includes placing the bladder in a microwave.
